(19) United States
(12) Patent Application Publication
(10) Pub. No.: US 2024/0174917 A1
(43) Pub. Date: May 30, 2024

(54) METHOD FOR PREPARING FLAT-SURFACED MAPbBr3 PEROVSKITE BLOCK AND USE THEREOF

(71) Applicant: University of Electronic Science and Technology of China, Yangtze River Delta Research Institute, Huzhou (CN)

(72) Inventors: Zhaojun QIN, Huzhou (CN); Weiwu CHEN, Huzhou (CN); Zhiming WANG, Huzhou (CN); Runbo ZHAO, Huzhou (CN); Yisen YAO, Huzhou (CN)

(21) Appl. No.: 18/384,045

(22) Filed: Oct. 26, 2023

(30) Foreign Application Priority Data
Nov. 29, 2022 (CN) 202211510826.3

(51) Int. Cl. C09K 11/06; C07F 7/24

(52) U.S. Cl. CPC C09K 11/06; C07F 7/24

(57) ABSTRACT

Provided herein is a method for preparing a flat-surfaced MAPbBr3 perovskite block and a use thereof. The preparation steps include: preparing a mixed solution formed by adding MABr and PbBr2 to a DMF solution; preparing a nickel foam mesh with the precursor solution; removing excess reaction liquid from the nickel foam mesh; and drying the nickel foam mesh to obtain the flat-surfaced MAPbBr3 perovskite block. It employs a solution-based method to fabricate MAPbBr3 perovskite on a nickel foam mesh, resulting in flat-surfaced MAPbBr3 perovskite blocks. The prepared perovskite can be utilized in the fields of solar cells, LEDs, and photoelectric hydrolysis. The method is simple and easy to operate, by using a solution-based method on a nickel foam mesh, flat-surfaced perovskite blocks can be formed, and the flat surface is beneficial for light absorption and energy conversion, thus enhancing the performance of the sample.

### CROSS-REFERENCE TO RELATED APPLICATIONS

This is a U. S. patent application which claims the priority and benefit of Chinese Patent Application Number 202211510826.3, filed on Nov. 29, 2022, the disclosure of which is incorporated herein by reference in its entirety.

### TECHNICAL FIELD

The present disclosure relates to the field of MAPbBr₃ perovskite, and more particularly, to a method for preparing a flat-surfaced MAPbBr₃ perovskite block and a use thereof.

### BACKGROUND

Lead halide perovskites CsPbX₃ (X=Cl, Br, I) have garnered widespread attention due to their unique optical properties. Exceptional optical characteristics and good chemical stability make them highly promising for applications in solar cells, photodetectors, lasers, and light-emitting diodes (LEDs) etc. On the other hand, the bandgap of lead halide perovskites can be modulated through anion exchange reactions. Replacing Cs⁺ cations in lead halide perovskites with organic MA⁺ cations results in organic-inorganic hybrid lead halide perovskites MAPbX₃ (MA=CH₃NH₃, X=Br, I, Cl), which garner extensive attention due to their strong light absorption properties. These perovskites have considerable potential for application in solar cells. Additionally, perovskites also serve as excellent catalysts for water splitting to produce hydrogen and oxygen. Therefore, a straightforward and easy-to-operate method for obtaining perovskites with flat surfaces is of particular importance.

### SUMMARY

Addressing the issues present in the background, the present disclosure provides a method for preparing a flat-surfaced MAPbBr₃ perovskite block, comprising the following steps:
S1: adding MABr and PbBr₂ powder into a DMF solution to form a precursor solution;
S2: stirring and heating the precursor solution until the temperature of the precursor solution reaches 60° C., then immersing a nickel foam mesh into the precursor solution and stirring for two hours;
S3: subsequently placing the nickel foam mesh with the precursor solution into a toluene solution for cleaning for 40-60 seconds, removing excess reaction liquid; and
S4: drying the nickel foam mesh on a heating stage for 30 minutes.

According to one or more embodiments, in step S1, the precursor solution is a mixture formed by adding 1 mmol of MABr powder and 1 mmol of PbBr₂ powder into 5 mL of DMF solution.

According to one or more embodiments, in step S2, the stirring and heating of the precursor solution are carried out for 3 minutes to ensure the temperature reaches 60° C., followed by immersing the nickel foam mesh into the precursor solution and stirring for two hours at 60° C.

According to one or more embodiments, in step S3, the nickel foam mesh with the precursor solution is cleaned in the toluene solution for 60 seconds.

According to one or more embodiments, in step S4, the heating stage is controlled to ensure the temperature of the nickel foam mesh reaches 95° C., with a drying time of 30 minutes.

According to one or more embodiments, the prepared flat-surfaced perovskite block has a dimension ranging from 0.5-2 μm.

Furthermore, there is provided a use of the flat-surfaced MAPbBr₃ perovskite block, the flat-surfaced MAPbBr₃ perovskite block thus prepared exhibits strong photoluminescence characteristics, with luminescence intensity reaching the order of 10⁴ and promising applications in the fields of solar cells, LEDs, and photoelectric hydrolysis.

Compared to the existing technology, the advantages of the present disclosure are:

1) Perovskite materials grow on a nickel foam mesh, expanding the application range of perovskites. The nickel foam mesh features a distinct porous structure, providing a large specific surface area, and growing MAPbBr₃ perovskite on the nickel foam mesh allows for the attachment of sufficient amounts of active materials per unit volume, enhancing the luminescent properties of the sample. Additionally, nickel material has good catalytic properties, and combining it with MAPbBr₃ perovskite effectively enhances the prospects for applications in the photoelectrocatalytic field.

2) The method for preparing perovskite in this disclosure is straightforward and easy to operate. Utilizing this method can produce flat-surfaced MAPbBr₃ perovskite blocks grown on the nickel foam mesh.

3) Preparing MAPbX₃ perovskite on a nickel foam mesh is a novel method for preparing perovskite, achieved by forming the flat-surfaced MAPbBr₃ perovskite block on the nickel foam mesh via a solution process. For optical materials, a flat surface results in fewer surface defects, which is beneficial for light absorption and energy conversion. Given the exceptional optical properties of perovskites, the perovskites prepared by this method are not only promising for use in solar cells and LEDs but may also be applicable in the field of photoelectric hydrolysis.

### BRIEF DESCRIPTION OF DRAWINGS

FIG. 1 is a SEM image of a nickel foam mesh;

FIG. 2 is a SEM image of a flat-surfaced MAPbBr₃ perovskite block;

FIG. 3 is a photoluminescence graph of a flat-surfaced MAPbBr₃ perovskite block.

### DETAILED DESCRIPTION

The technical solutions in the embodiments of the present disclosure will be clearly and completely described below in conjunction with the accompanying drawings in the embodiments of the present disclosure. Apparently, the described embodiments are only part of the embodiments of the present disclosure. Based on the embodiments of the present disclosure, all other embodiments obtained by those skilled in the art without inventive effort shall fall within the scope of protection of the present disclosure.

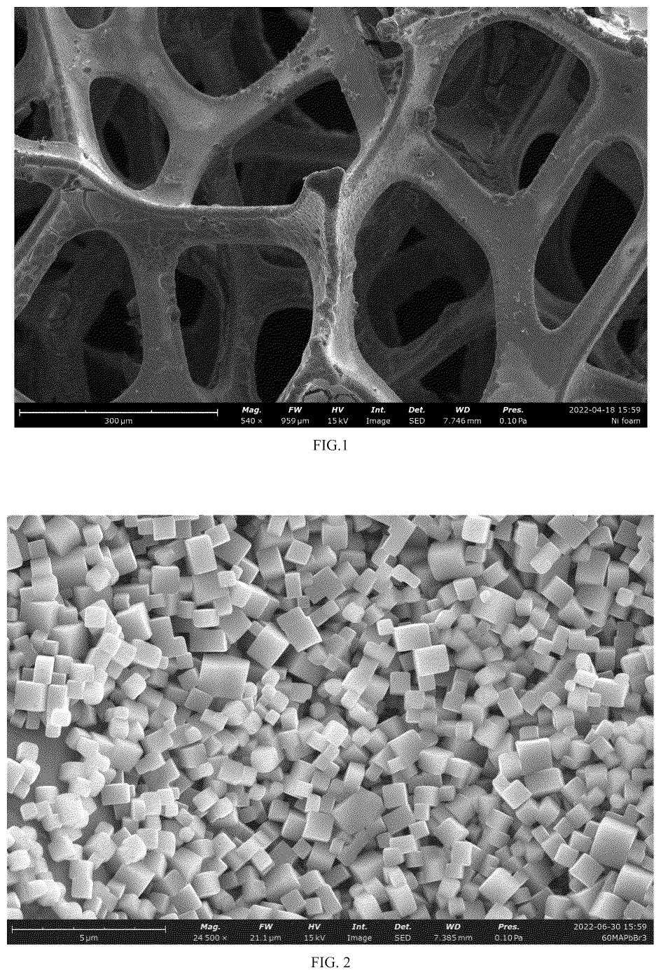

The present disclosure provides a method for preparing a flat-surfaced MAPbBr₃ perovskite block, which includes the following steps:
S1: adding MABr and PbBr₂ powder into a DMF solution to form a homogeneous precursor solution;
S2: stirring and heating the precursor solution until the temperature of the precursor solution reaches 60° C., then immersing a nickel foam mesh as shown in FIG. 1 into the precursor solution and stirring for two hours;
S3: subsequently placing the nickel foam mesh with the precursor solution into a toluene solution for cleaning for 40-60 seconds, removing excess reaction liquid; and
S4: drying the nickel foam mesh on a heating stage for 30 minutes.

According to one or more embodiments, in step S1, the precursor solution is a mixture formed by adding 1 mmol of MABr powder and 1 mmol of PbBr₂ powder into 5 mL of DMF solution.

According to one or more embodiments, in step S2, the stirring and heating of the precursor solution are carried out for 3 minutes to ensure the temperature reaches 60° C., followed by immersing the nickel foam mesh in the precursor solution and stirring for two hours at 60° C.

According to one or more embodiments, in step S3, the nickel foam mesh with the precursor solution is cleaned in the toluene solution for 60 seconds.

According to one or more embodiments, in step S4, the heating stage is controlled to ensure the temperature of the nickel foam mesh reaches 95° C., with a drying time of 30 minutes.

According to one or more embodiments, the prepared flat-surfaced perovskite block has a dimension ranging from 0.5-2 μm.

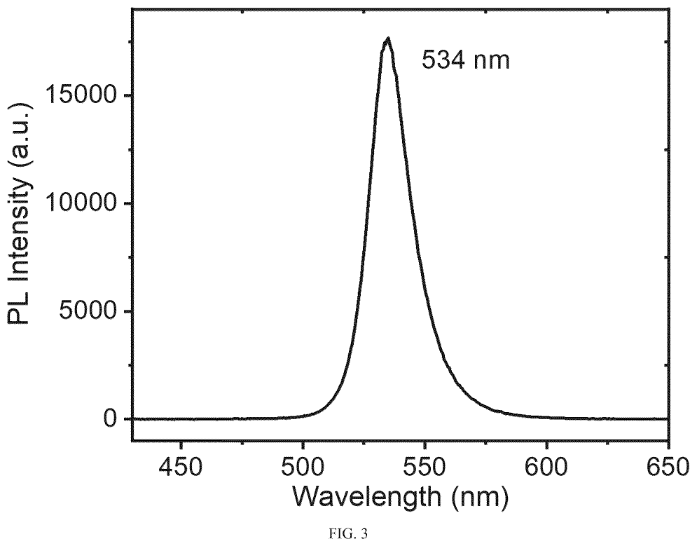

According to one or more embodiments, a use of the flat-surfaced MAPbBr₃ perovskite block is provided, the flat-surfaced MAPbBr₃ perovskite block thus prepared as shown in FIG. 2 exhibits strong photoluminescence characteristics, with luminescence intensity reaching the order of 10⁴ as shown in FIG. 3 and promising applications in the fields of solar cells, LEDs, and photoelectric hydrolysis.

The foregoing merely describes specific embodiments of the present disclosure, which is not intended to limit the scope of protection of the present disclosure. The scope of the present disclosure should be defined by the appended claims. Any modifications, equivalent variations or substitutions, and improvements made within the spirit and principle of the present disclosure by those skilled in the art according to the disclosed technical scope should be included in the protection scope of the present disclosure.

What is claimed is:

1. A method for preparing a flat-surfaced MAPbBr₃ perovskite block, comprising the following steps:
S1: adding MABr and PbBr₂ powder into a DMF solution to form a precursor solution;
S2: stirring and heating the precursor solution until the temperature of the precursor solution reaches 60° C., then immersing a nickel foam mesh into the precursor solution and stirring for two hours;
S3: placing the nickel foam mesh with the precursor solution into a toluene solution for cleaning for 40-60 seconds, removing excess reaction liquid; and
S4: drying the nickel foam mesh on a heating stage for 30 minutes.

2. The method for preparing the flat-surfaced MAPbBr₃ perovskite block according to claim 1, wherein, in step S1, the precursor solution is a mixture formed by adding 1 mmol of MABr powder and 1 mmol of PbBr₂ powder into 5 mL of DMF solution.

3. The method for preparing the flat-surfaced MAPbBr₃ perovskite block according to claim 1, wherein, in step S2, the stirring and heating of the precursor solution are carried out for 3 minutes to ensure the temperature reaches 60° C., followed by immersing the nickel foam mesh into the precursor solution and stirring for two hours at 60° C.

4. The method for preparing the flat-surfaced MAPbBr₃ perovskite block according to claim 1, wherein, in step S3, the nickel foam mesh with the precursor solution is cleaned in the toluene solution for 60 seconds.

5. The method for preparing the flat-surfaced MAPbBr₃ perovskite block according to claim 1, wherein, in step S4, the heating stage is controlled to ensure the temperature of the nickel foam mesh reaches 95° C., with a drying time of 30 minutes.

6. The method for preparing the flat-surfaced MAPbBr₃ perovskite block according to claim 1, wherein, the prepared perovskite block has a flat surface and a dimension ranging from 0.5-2 μm.

7. A use of the flat-surfaced MAPbBr₃ perovskite block according to claim 1, the flat-surfaced MAPbBr₃ perovskite block exhibits strong photoluminescence characteristics, with luminescence intensity reaching the order of 10⁴.
